(19) United States
(12) Patent Application Publication
(10) Pub. No.: US 2024/0151467 A1
(43) Pub. Date: May 9, 2024

(54) SYSTEMS AND METHODS FOR MANUFACTURING SOLID OXIDE CELLS

(71) Applicant: Purdue Research Foundation, West Lafayette, IN (US)

(72) Inventor: Yi Xie, West Lafayette, IN (US)

(73) Assignee: Purdue Research Foundation, West Lafayette, IN (US)

(21) Appl. No.: 18/387,456

(22) Filed: Nov. 6, 2023

Related U.S. Application Data
(60) Provisional application No. 63/423,904, filed on Nov. 9, 2022.

(51) Int. Cl. F27B 5/04; B22F 3/10; B28B 11/24; C25B 9/19; C25B 13/07; F27D 19/00; G01J 5/48; G01N 1/44; H01M 4/88; H01M 8/1246; H05B 3/14

(52) U.S. Cl. CPC F27B 5/04; B22F 3/10; B28B 11/243; C25B 9/19; C25B 13/07; F27D 19/00; G01J 5/485; G01N 1/44; H01M 4/8885; H01M 8/1246; H05B 3/145; H01M 2008/1293

(57) ABSTRACT

A system includes a vacuum chamber configured to enclose the material sample within, an infrared camera, a power supply, a heating stage, and a temperature controller. The infrared camera is configured to measure a temperature within the vacuum chamber and generate an output temperature value. The heating stage is coupled with a pair of electrodes, and the pair of electrodes are configured to apply a power signal to the heating stage from the power supply to affect the temperature within the vacuum chamber. The temperature controller is configured to receive the output temperature value and selectively adjust the temperature within the vacuum chamber to thereby maintain the temperature within the vacuum chamber within a desired temperature range.

### CROSS-REFERENCE TO RELATED APPLICATIONS

This application is related to and claims the priority benefit of U.S. Provisional Patent Application No. 63/423,904, entitled “Systems and Methods for Manufacturing Solid Oxide Cells,” filed Nov. 9, 2022, the contents of which are hereby incorporated by reference in their entirety into the present disclosure.

### TECHNICAL FIELD

The present application relates to fabricating materials, and more particularly to heat treatments and sintering of materials used in solid oxide fuel cells and electrolysis cells.

### BACKGROUND

This section introduces aspects that may help facilitate a better understanding of the disclosure. Accordingly, these statements are to be read in this light and are not to be understood as admissions about what is or is not prior art.

Ceramic devices can include electrochemical devices which convert chemically bound energy directly into electrical energy. More specific examples of ceramic electrochemical devices are solid oxide cells, which, depending on the desired application, may be solid oxide fuel cells (SOFCs) or solid oxide electrolysis cells (SOECs). Due to their common structure, the same cell may be used in SOFC applications as well as SOEC applications. In SOFCs, fuel is fed into the cell and converted into power. In SOECs, power is applied to produce fuel. As such, these cells are often referred to as “reversible” SOCs. Solid oxide cells may have various designs, including planar and tubular cells. Typical configurations include an electrolyte layer being sandwiched between two electrode layers. During operation of the cell, usually at temperatures of about 500° C. to about 1 100° C., one electrode is in contact with oxygen or air, while the other electrode is in contact with a fuel gas.

The voltage of a single cell is around 1 volt, depending on the fuel and oxidant used. To obtain higher voltage and power from the SOCs, it is therefore necessary to stack many cells together. The most common manufacturing method for SOC planar stacks comprises the manufacture of single cells. The cells are subsequently stacked together with interconnects, current collectors, contact layers, and seals. After assembly, the stacks are often consolidated and sealed by heat treatment under a vertical load to ensure sealing as well as electrical contact between the components.

The sintering procedure and temperature of the device, or the individual cells, is critical for finetuning the properties of the respective layers. However, the high temperatures of the sintering process often add to the overall manufacturing costs of the device, thus inhibiting mass production of the devices to date. Hence, there is a need for improvements in the devices and methods used for the sintering process.

### SUMMARY

Aspects of this disclosure describe systems to more quickly and cheaply manufacture solid oxide cells. In some aspects of the present disclosure, such a system can include a vacuum chamber configured to enclose the material sample within, an infrared camera, a power supply, a heating stage, and a temperature controller. The infrared camera can be configured to measure a temperature within the vacuum chamber and can generate an output temperature value. The heating stage can be coupled with a pair of electrodes, and the pair of electrodes can be configured to apply a power signal to the heating stage from the power supply to affect the temperature within the vacuum chamber. The temperature controller can be configured to receive the output temperature value and selectively adjust the temperature within the vacuum chamber to thereby maintain the temperature within the vacuum chamber within a desired temperature range.

Additional aspects of this disclosure provide methods to manufacture solid oxide cells. In some aspects, such a method can include creating a vacuum within a vacuum chamber, the vacuum chamber including a heating stage positioned therein and a material sample disposed on the heating stage. The method can further include applying an electrical current to the heating stage via a power supply such that the electrical current increases a temperature within the vacuum chamber, determining a temperature within the vacuum chamber via an infrared camera, and comparing the determined temperature to a desired temperature profile. The method can further include providing a control signal to the power supply based on the comparison, and adjusting the electrical current from the power supply to attain the desire temperature profile within the vacuum chamber based upon the control signal.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a schematic of one embodiment of a high temperature ultra-fast (HTUF) system;

FIG. 2A depicts examples of HTUF-sintered SOEC full cells;

FIG. 2B depicts a graphical output diagram showing a temperature profile for the HTUF-sintered SOEC full cells of FIG. 2A;

FIG. 2C depicts an experimental output showing a cross-sectional scanning electron microscope (SEM) image of one exemplary SOEC full cell sintered by the HTUF system of FIG. 1;

FIG. 3A depicts an elevational view of one exemplary heating stage configured for use with an HTUF system;

FIG. 3B depicts a top plan view of the heating stage of FIG. 3A; and

FIG. 3C depicts a cross-sectional view of the heating stage of FIG. 3A, taken along cutting plane A-A of FIG. 3B.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

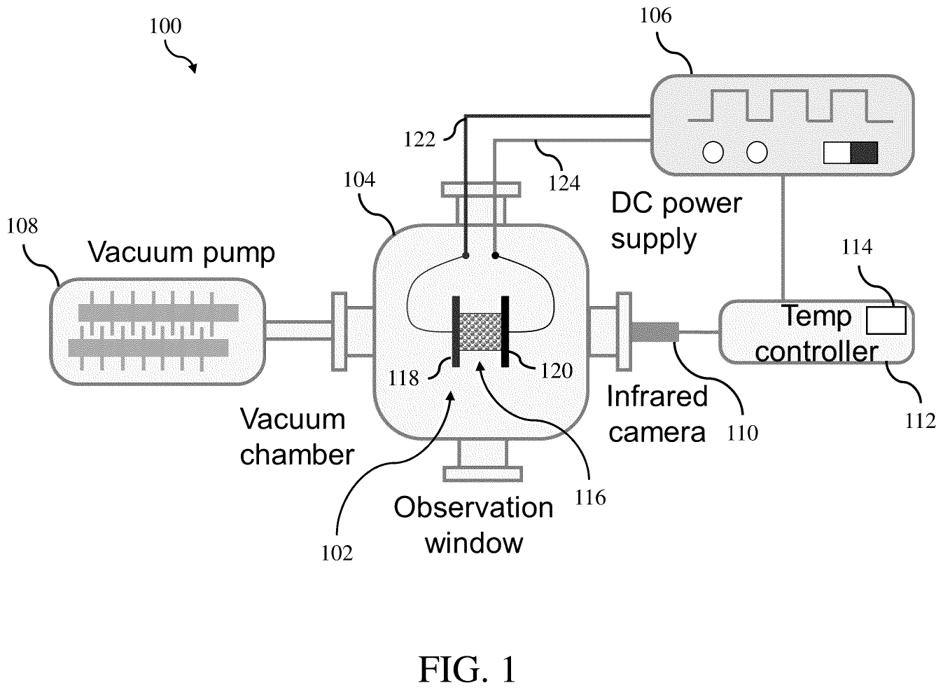

The high temperature ultra-fast (HTUF) system described herein enables fast heating and sintering of a variety of materials, including solid oxide fuel and electrolysis cells, functional and structural ceramics, metals and alloys, and ceramic-metal composite materials. One exemplary embodiment of the HTUF system is shown in FIG. 1. The system (100) is composed of a heating stage (102) within a vacuum chamber (104), an electrical power supply (106), a vacuum pump (108) such as a high-vacuum pump, an infrared camera (110), and a temperature controller (112) configured with a data processor (114). In some embodiments, the data processor includes a memory storing a software program, such as a LabView-based program or similar, that is operable to control temperature profiles within the vacuum chamber (104). In some embodiment, the HTUF system (100) can heat up to ˜3000° C. from room temperature in a few seconds. The working atmosphere within the vacuum chamber (104) is flexible, allowing to be vacuum, argon, nitrogen, air and other specialty gases.

More particularly, the vacuum pump (108) is configured to remove air from the vacuum chamber (104), providing an oxygen-free environment to oxygen-sensitive material or samples (116). The power supply (106), which may be a DC power supply in some embodiments, and can be a 10 kW supply programmable with 0-30 volts of direct current. The infrared camera (110) is configured to measure the temperature of material or sample (116) during a heating and sintering process. The temperature controller (112) controls the power output of the DC power supply (106) to achieve and maintain the temperature of material or sample (116) at a user predefined temperature setting. Within the vacuum chamber (102), two electrodes (118, 120) are configured to receive a power signal from the DC power supply (106) via wires (122, 124), which may be 2/0 weld cables, to raise the temperature within the vacuum chamber (104) to sinter the material or sample (116).

The system (100) can make a large-size pellet sample or multiple pellet samples at a time. This capability is accomplished through the large and size-adjustable heating stage (102). The heating stage (102) can be, in some particular applications, about 2-inches wide and 3-inches long and can make more than one pellet samples with different sizes at a time with the maximum size less than 2 by 3 inch. The heating stage (102) can be scaled up to make more pellets with a larger size if a more powerful electricity supply system is available in the lab. Multiple alloy and ceramic samples with different sizes, of diameter ranging from 10 to 30 mm, have been made by the system (100). These samples were made individually to demonstrate the sinterability of specific materials. Technically, they may be made at a time after appropriate modifications of the system.

In some applications, sintering can be achieved SOFC/SOEC from green tape that includes an anode layer, an electrolysis layer, and a cathode layer. The system (100) can sinter (i.e., make powder particles in the green tape inter-diffuse toward each other and grow into grains) the 3-layered green tape through rapid heating and holding at the temperature for a few seconds, followed by a natural cooling. The specific heating profile (i.e., the dwell temperature and dwell time) varies between different chemical compositions and the size of powder particles of green tapes. Accordingly, the electrochemical performance of the sintered SOFC/SOEC depends on the chemical composition and the size of powder particles

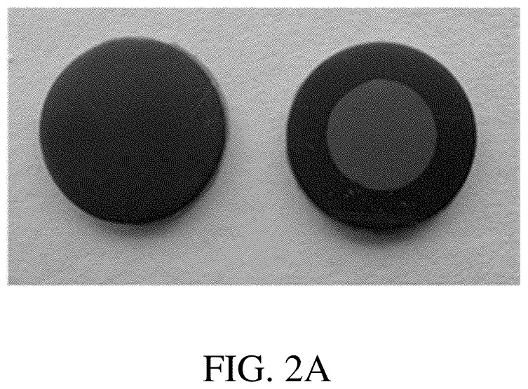

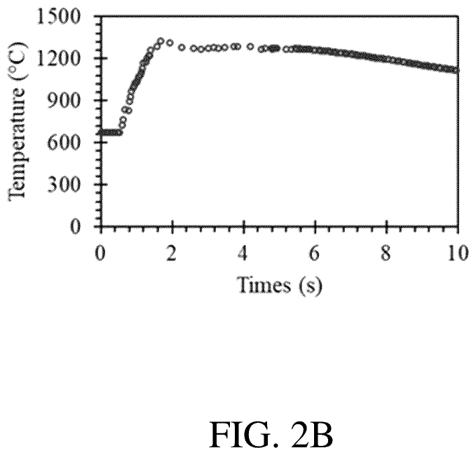

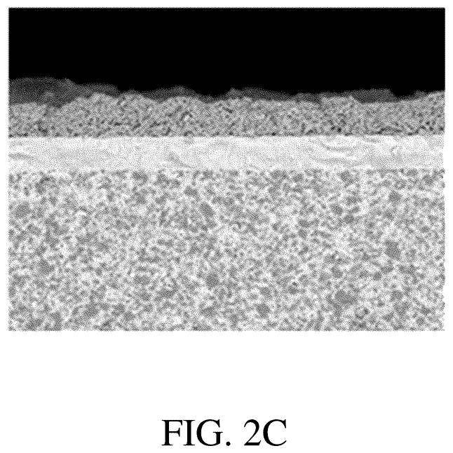

The fast-heating process and unique configuration of this system (100) significantly lower the time and energy consumption compared to conventional sintering technology. The SOEC fuel cells have been sintered using HTUF (100), as shown in FIG. 2A, with an appropriate sintering temperature profile for the SOEC fuel cells, measured by the infrared camera (100) as shown in FIG. 2B. The HTUF processing can be completed in 10 seconds or less, and the sample (116) may be heated from room temperature to 1300° C. in two seconds or less (note that temperature below 700° C. were not measured due to the camera filter). In this experiment, it may take four hours or more to sinter an equivalent SOEC pellet using a conventional furnace. If it is assumed that both the HTUF (100) and the conventional furnace worked at full power (HTUF 10 kW, conventional furnace 1.2 kW), then the HTUF cost 1×10⁵ J electricity and the furnace cost 1.73×10⁷ J electricity. Accordingly, the energy required by the HTUF is only 0.58% of the conventional furnace.

The HTUF system (100) not only lowers time and energy consumption, but also eliminates the carbon contamination on sample surface. For the spark plasma sintering (SPS), the carbon contamination issue, caused by the interdiffusion between graphite die and sample and the reduction reaction, has become a significant concern. It's well known that the SPS processing is a combined effect of pressure and heat, and it requires 10-20 minutes to complete a sintering profile. A thick carbon-reaction layer has been found on the SPS-sintered SOEC sample. On the contrary, the HTUF technology may resolve the carbon contamination issue through two thrusts. First, the HTUF is pressure-less, which minimizes the contact between the graphite heating element and sample, thus reducing the diffusion and reaction thermodynamics of carbon and sample material. The pressure-less mode also avoids fracture of samples caused by external load, which is an issue found in the SPS sintering. Second, the fast heating ensures the sample is sintered within tens of seconds. Sintering indicates the powder particles are diffused and combined into a solid bulk with pores disappearing. Thus, the effective surface area reacting with carbon is reduced, and thus the diffusion and reaction kinetics of carbon and sample material is significantly reduced. FIG. 1D shows the cross section of the HTUF-sintered SOEC with anode, cathode, and electrolysis layers. The result indicates the sample surface is free of carbon diffusion or reaction layer.

In addition to the three distinct advantages to SOEC manufacturing as mentioned above, the other advantages of the HTUF system is summarized in the following points: 1) the fast heat ramp with short dwell time can densify materials while suppressing grain growth; 2) the system is able to process difficult-to-sinter materials due to the extraordinary working temperature; 3) the system can make multiple inch-size samples at a time, thus maximizing manufacturing efficiency and accelerating screening of high-throughput tests and quick fabrication of materials in a wide range of sintering parameters; 4) upgrading the system to fit larger-size material for industry application is fully doable; and 5) the system can advance the chemical effects as the ultrafast process aids in mitigating the loss of volatile elements and retaining the stoichiometry.

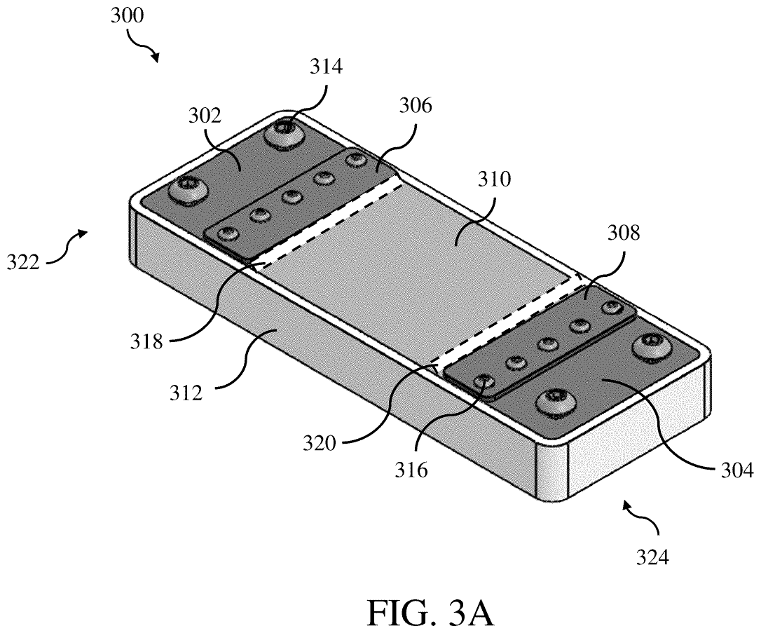

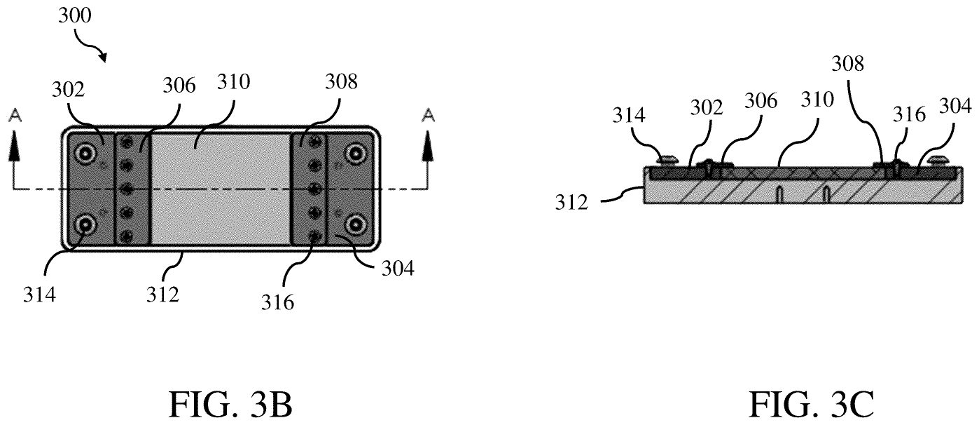

FIG. 3A illustrates a schematic of one exemplary heating stage (300) to perform the functions described herein with regard to heating stage (102). Heating stage (300) includes a first electrode (302), a second electrode (304), a first compression plate (306), a second compression plate (308), and a ceramic plate (310) all housed within an insulated frame (312) and rigidly held into place such as by one or more fasteners (314, 316) (e.g., screws, pins, or similar). One or more of the fasteners (314, 316) may be connected with electrical wires for generating heat on the heating stage (300), such as by being coupled with wires (122, 124). In particular, one end (322) of the heating stage (300) may be coupled with a first electrode (e.g., electrode (118) of power supply (106)), while the opposing end (324) of the heating stage (300) may be coupled with a second electrode (e.g., electrode (120) of power supply (106)) having the opposite polarity.

The heating stage (300) can be operable in a multitude of different heating modes. In one example embodiment, heating stage (300) includes two heating modes. In the first heating mode, a pair of graphite foam strips (318, 320) can be connected with or otherwise in contact with the compression plates (306, 308), respectively, whereby the graphite foam strips (318, 320) receive the power signal. Accordingly, the sample or material (116) to be sintered may be positioned between the pair of graphite foam strips (318, 320) to be rapidly heated through heat conduction resulting from the power signal. In the second heating mode, the sample or material (116) may be coupled directly in contact with the compression plates (306, 308), therefore being rapidly heated directly from the compression plates (306, 308) which receive the power signal.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

1. A system for heating a material sample, comprising:
(a) a vacuum chamber configured to enclose the material sample within;
(b) an infrared camera configured to measure a temperature within the vacuum chamber and generate an output temperature value;
(c) a power supply;
(d) a heating stage coupled with a pair of electrodes, wherein the pair of electrodes are configured to apply a power signal to the heating stage from the power supply to affect the temperature within the vacuum chamber; and
(e) a temperature controller configured to receive the output temperature value and selectively adjust the temperature within the vacuum chamber to thereby maintain the temperature within the vacuum chamber within a desired temperature range.

2. The system of claim 1, further comprising a vacuum pump coupled with the vacuum chamber and configured to create a vacuum within the vacuum chamber.

3. The system of claim 1, wherein the material sample includes at least one of a solid oxide fuel cell, solid oxide electrolysis cell, a ceramic, a metal, a metal alloy, and a ceramic-metal composite material.

4. The system of claim 1, wherein the power supply includes a direct-current power supply configured to selectively output up to 10 kilowatts of power.

5. The system of claim 1, wherein the power supply includes a direct-current power supply configured to selectively output between 0-30 volts of direct current.

6. The system of claim 1, the heating stage further comprising:
a pair of compression plates disposed on opposing sides of the heating stage; and
a ceramic insulation plate disposed between the pair of compression plates and configured to retain the material sample thereon.

7. The system of claim 1, the heating stage further comprising:
a pair of compression plates disposed on opposing sides of the heating stage;
a pair of graphite strips, wherein a first graphite strip of the pair of graphite strips is positioned in contact with a first compression plate of the pair of compression plates, and a second graphite strip of the pair of graphite strips is positioned in contact with a second compression plate of the pair of compression plates;
a ceramic insulation plate disposed between the pair of graphite strips and configured to retain the material sample thereon.

8. The system of claim 1, wherein each electrode of the pair of electrodes is coupled to the power supply via a 2/0 weld cable.

9. A method of sintering a material, comprising:
(a) creating a vacuum within a vacuum chamber, wherein the vacuum chamber includes a heating stage positioned therein, wherein a material sample is positioned on the heating stage;
(b) applying an electrical current to the heating stage via a power supply, wherein the electrical current increases a temperature within the vacuum chamber;
(c) determining a temperature within the vacuum chamber via an infrared camera;
(d) comparing the determined temperature to a desired temperature profile;
(e) based upon the comparison, providing a control signal to the power supply; and
(f) based upon the control signal, adjusting the electrical current from the power supply to attain the desire temperature profile within the vacuum chamber.

10. The method of claim 9, wherein the material includes at least one of a solid oxide fuel cell, solid oxide electrolysis cell, a ceramic, a metal, a metal alloy, and a ceramic-metal composite material.

11. A system, comprising:
(a) a vacuum chamber configured to enclose a material sample within;
(b) an infrared camera configured to measure a temperature within the vacuum chamber and to generate an output temperature value;
(c) a heating stage coupled with a pair of electrodes, wherein the pair of electrodes are collectively operable to apply a power signal to the heating stage to affect the temperature within the vacuum chamber, wherein the heating stage includes:
(i) a pair of compression plates disposed on opposing sides of the heating stage, and
(ii) a pair of graphite strips, wherein a first graphite strip of the pair of graphite strips is positioned in contact with a first compression plate of the pair of compression plates, and a second graphite strip of the pair of graphite strips is positioned in contact with a second compression plate of the pair of compression plates; and
(d) a temperature controller configured to receive the output temperature value and selectively adjust the temperature within the vacuum chamber to thereby maintain the temperature within the vacuum chamber within a desired temperature range.

12. The system of claim 11, wherein the material sample includes at least one of a solid oxide fuel cell, solid oxide electrolysis cell, a ceramic, a metal, a metal alloy, and a ceramic-metal composite material.

13. The system of claim 11, further comprising a direct-current power supply configured to selectively output up to 10 kilowatts of power to the pair of electrodes.

14. The system of claim 11, further comprising a direct-current power supply configured to selectively output between 0-30 volts of direct current to the pair of electrodes.

15. The system of claim 11, wherein the heating stage includes a ceramic insulation plate disposed between the pair of graphite strips, wherein the ceramic insulation plate is configured to retain the material sample thereon.
